(19) United States
(12) Patent Application Publication
(10) Pub. No.: US 2008/0007007 A1
(43) Pub. Date: Jan. 10, 2008

(54) Sealing flange for sealing a shaft

(75) Inventor: Rolf Johnen, Wiemersdorf (DE)

Correspondence Address: Paul Grandinetti;LEVY & GRANDINETTI, Suite 408, 1725 K Street, N.W., Washington, DC, 20006-1419, US

(73) Assignee: Dichtungstechnik G. BRUSS GmbH & Co. KG, Hoisdorf (DE)

(21) Appl. No.: 11/359,603

(22) Filed: Feb. 23, 2006

(30) Foreign Application Priority Data
Feb. 24, 2005 (DE) 202005003345.6

(51) Int. Cl. F16J 9/00

(52) U.S. Cl. 277/317

(57) ABSTRACT

The application relates to a sealing flange for sealing a shaft, in particular the crankshaft in a motor vehicle engine, with a substantially metallic flange body (11) which has a shaft opening (12) for passage of the shaft, the sealing flange including a sealing element (15) surrounding the shaft, fastening devices (13) for fastening the sealing flange (10) to the engine to be sealed, and a plastic sensor holder (20) mounted on the flange body (11) for holding a sensor element (16), wherein the flange body (11) is weakened in the region of the sensor holder (20).

The invention concerns a sealing flange according to the introductory part of claim 1.

Such a sealing flange with a plastic block for receiving a sensor for the engine speed is known from EP 1 063 455 A2. Here, the connected plastic is supported with a dimensionally stable carrier made of steel sheet and fixed to the structure. However, it turned out that the region of connection of the plastic block to the metal carrier is at risk of fracture.

It is the object of the present invention to provide a fracture-resistant sealing flange with low manufacturing costs and connection of the sensor element in a precise position.

The invention achieves this object by the means of claim 1. The invention starts from the finding that the region of connection of the sensor to the flange body is the part of the sealing flange most subject to stress dynamically. The solution according to the invention now provides a weakening of the high-strength flange body precisely in this region which is subject to high stress, which at first glance is surprising. In other words, in the region of the sensor holder a portion of the high-strength metallic material of the flange body is replaced by the lower-strength plastic of the sensor holder, which seems to be contrary to the supporting function of the flange body. Tests have shown, however, that by selective weakening of the flange body in this critical region the vibration and damping behaviour of the sealing flange can be influenced in such a way that fractures can be prevented from occurring.

One simple and therefore preferred possibility for weakening the flange body in the region of the sensor holder provides a recess in a base plate of the flange body. This means that the flange body in this region has a reduced radial extent compared with the average radial extent.

“Radial” here means in relation to the shaft axis. The invention is, however, not restricted to this. For example, a base plate of the flange body with a reduced thickness in the region of the sensor holder can also be provided.

According to a preferred aspect, the choice of materials used has special significance. To reduce the manufacturing costs, it is advantageous if the materials for the sensor holder, the static seal and the binder for the PTFE sealing disc have similar processing properties so that they can be bonded to the metallic carrier in one step. This applies if thermosetting plastic is used for the sensor holder and elastomeric sealing materials for the static and dynamic seals or in the event that a dynamic PTFE sealing lip is bonded by an elastomeric intermediate layer to the metal of the carrier flange.

Further advantageous characteristics and embodiments of the invention are apparent from the subsidiary claims and the following description of the invention with reference to the attached drawings. These show:

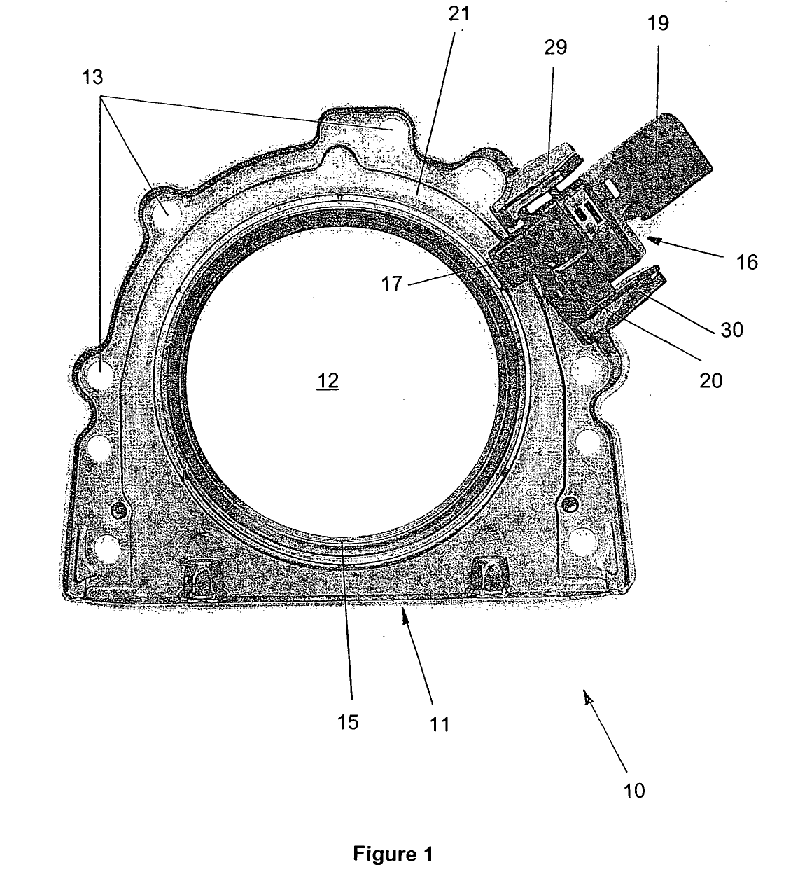

FIG. 1: a top view of a sealing flange from the side of the environment;

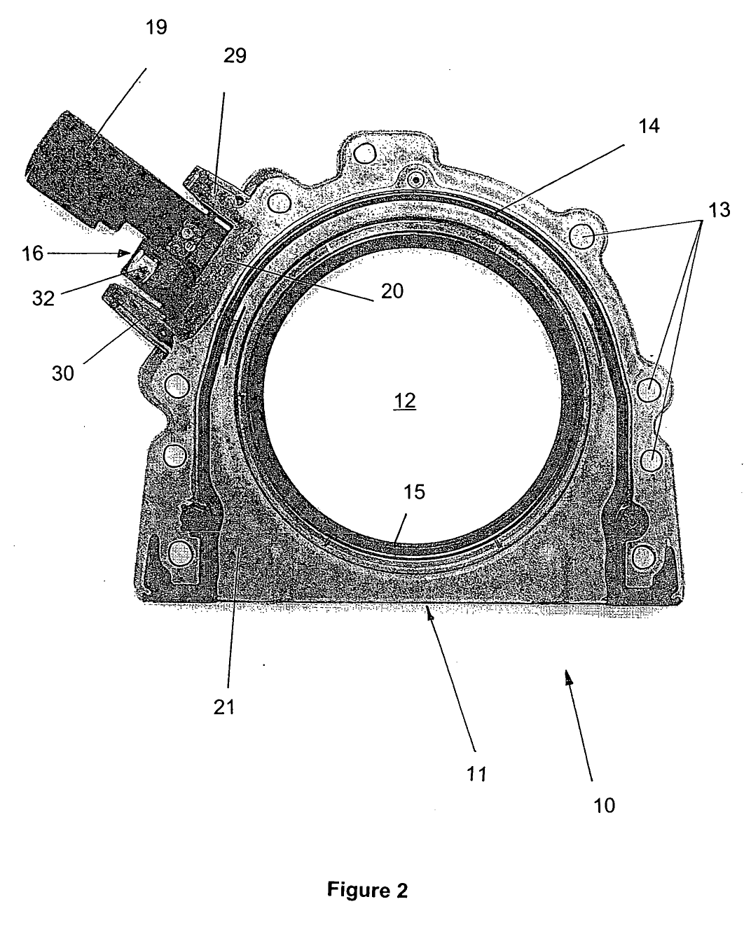

FIG. 2: a top view of a sealing flange from the engine side;

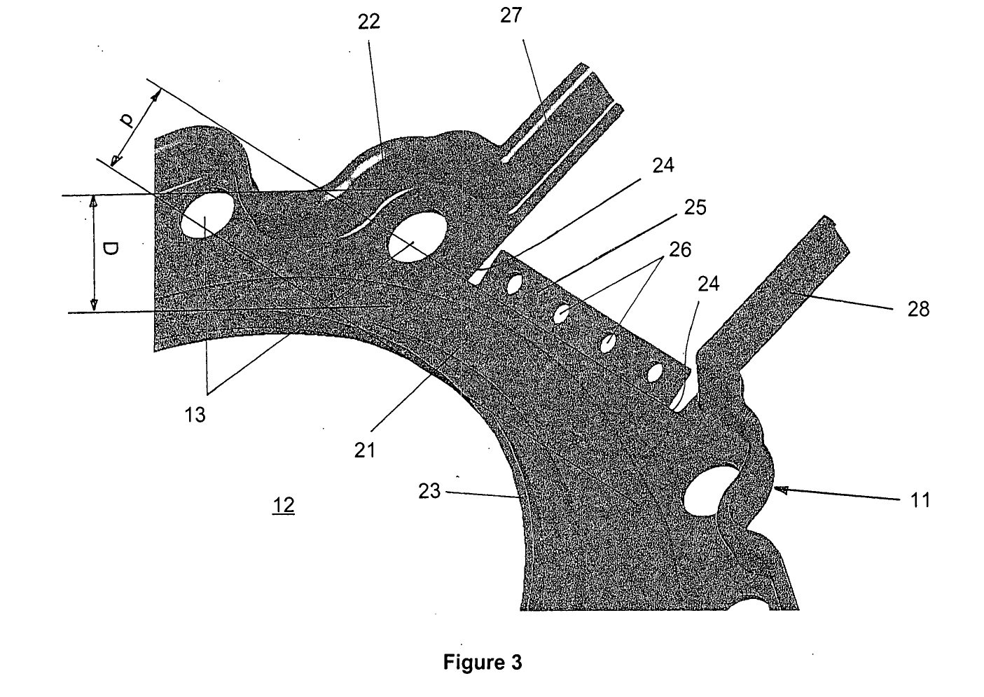

FIG. 3: a perspective view of a flange body in the region of the sensor holder from the side of the environment;

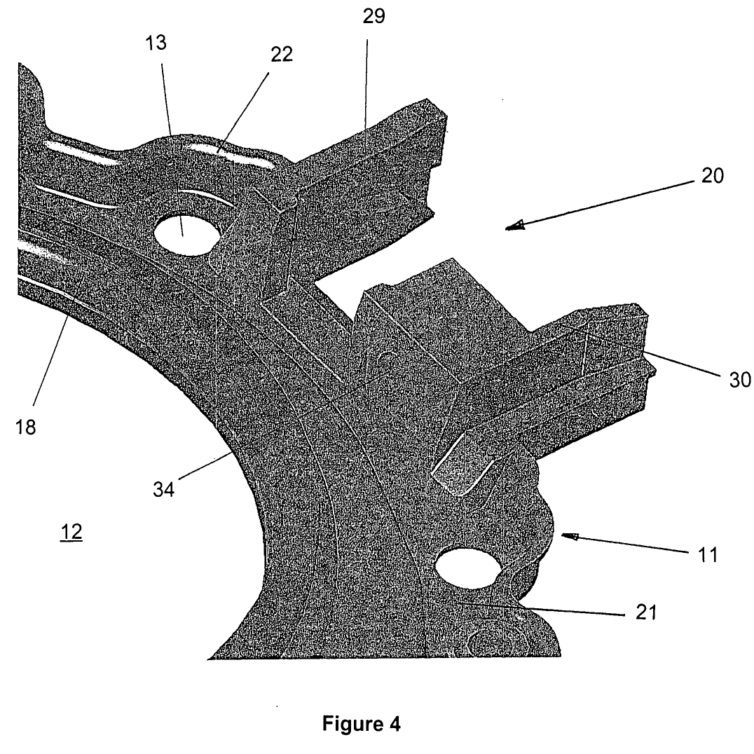

FIG. 4: a perspective view of a sealing flange in the region of the sensor holder from the side of the environment;

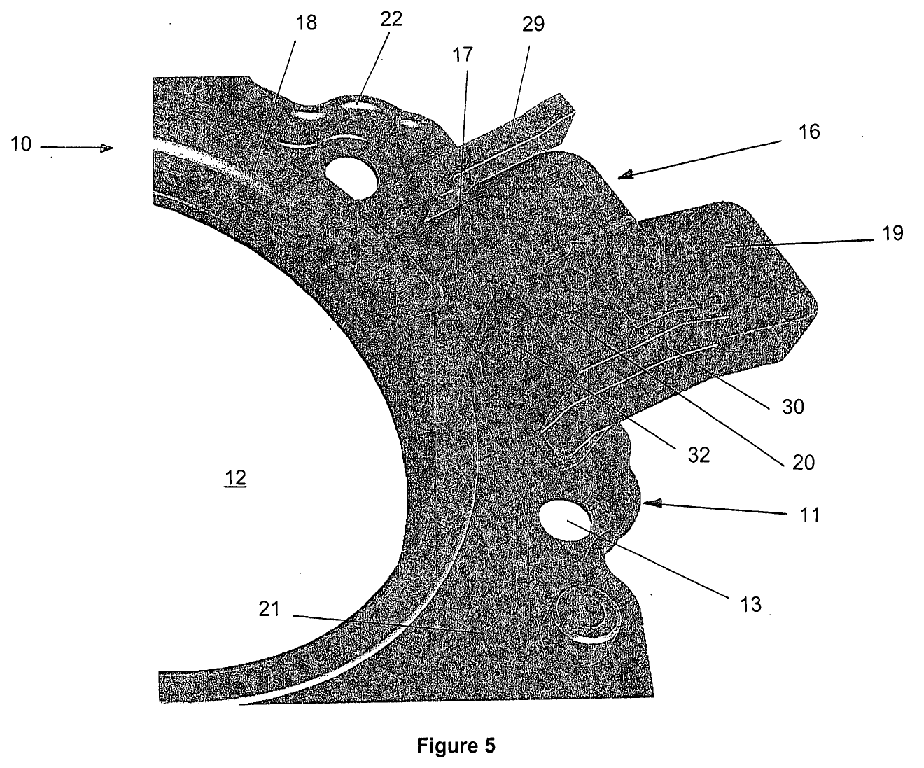

FIG. 5: a perspective view of a sealing flange in the region of the sensor holder with sensor element from the side of the environment; and

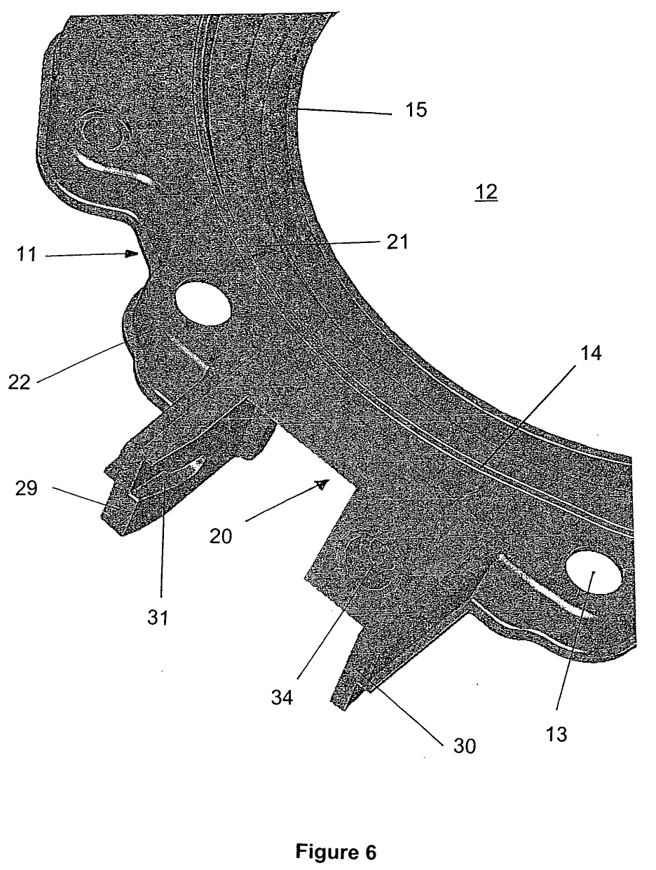

FIG. 6: a perspective view of a sealing flange in the region of the sensor holder from the engine side.

The sealing flange 10 includes a flange body 11 which has a central opening 12 for the passage of a crankshaft, not shown, in a motor vehicle engine. The flange body 11 has fastening openings 13 for fastening the sealing flange 10 to the motor vehicle engine to be sealed. On the engine side of the sealing flange 10 is accordingly provided a static sealing element 14. The shaft opening 12 is provided with an annular dynamic sealing element 15. The flange body 11 has the form of a substantially annular base plate 21 with an outer collar 22 and an inner collar 23 for fastening the dynamic sealing element 15.

At the peripheral edge of the flange body 11 is mounted a sensor element 16 which has a sensor 17 which cooperates with a signal-generating element 18 attached to the shaft, for example, a ring element provided with a magnet structure. The signal-generating element 18 induces in the sensor 17 an electrical signal dependent on the speed of rotation of the shaft, for example, a fixed number of pulses per revolution of the shaft, which is picked off via a connector 19, for example.

A sensor holder 20 made of plastic is connected to the flange body 11 at its peripheral edge. As can best be seen from FIG. 3, the flange body 11 is weakened in the region of the sensor holder 20. This weakening is formed by a U-shaped, outwardly opening recess 24 in the base plate 21 of the flange body 11. The radial extent d of the flange body 11 in the region of the sensor holder 20 is therefore substantially smaller than the average radial extent D of the flange body 11. “Substantially smaller” here means at least 15%, preferably at least 20%, further preferably at least 25% smaller. In other words, in the region of the sensor holder 20 a portion of the high-strength metallic material of the flange body 11 is replaced by the lower-strength plastic of the sensor holder 20.

The flange body 11 is preferably made of steel sheet. But other metallic materials are possible too, for example, aluminium or suitable alloys. As a rule, the static seal 14 is made of an elastomeric material. For the dynamic shaft seal 15 two different variants can be selected, either it is made of an elastomeric material preferably based on a fluorocaoutchouc and integrally formed direct onto the flange body, or as a prefabricated sealing disc made of a PTFE plastic it is bonded to the flange body by an elastomeric intermediate layer.

To produce a particularly stable and fracture-resistant connection of the sensor holder 20 to the flange body 11, preferably the following characteristics are provided. On the base plate 21 of the flange body 11 is provided an additional connecting element in the form of a strip 25 which is preferably arranged in the recess 24 in the flange body 11 and in the present case is oriented approximately tangentially to the shaft opening 12. The strip 25 has a plurality of through-holes 26 which are used for form-fit connection of the sensor holder 20 to the flange body 11, to ensure permanent precise positioning of the sensor holder 20 relative to the flange body 11.

The flange body 11 preferably has at least one, preferably two radially outwardly protruding bars 28, 29 for lateral connection to the sensor holder 20 or corresponding arms 29, 30 of the sensor holder 20. The bars 28, 29 of the flange body 11 can be designed as extensions of the outer collar 22, for example. The sensor holder 20 is therefore generally U-shaped in the present example.

The sensor element 16 is connected to the sensor holder 20 so as to be releasable with little effort by means of a bolt 32 which engages through a through-hole through the sensor element 16 in a threaded bore 34 of the sensor holder 20.

In at least one radial arm 29 of the sensor holder 20 can be provided a guide 31 in which engages a corresponding pin of the sensor element 16. The guide 31 and corresponding pin can be used for precise positioning of the sensor element 16 relative to the sensor holder 20.

1. Sealing flange for sealing a shaft, in particular the crankshaft in a motor vehicle engine, comprising a substantially metallic flange body which has a shaft opening for passage of the shaft, the sealing flange including:
a sealing element surrounding the shaft,
fastening devices for fastening the sealing flange to the engine to be sealed, and
a plastic sensor holder mounted on the flange body for holding a sensor element, wherein the flange body is weakened in the region of the sensor holder.

2. Sealing flange according to claim 1, wherein a base plate of the flange body in the region of the sensor holder has a recess.

3. Sealing flange according to claim 2, wherein the sensor holder and the sealing elements are made of materials with similar processing properties.

4. Sealing flange according to claim 3, wherein the sealing elements are made of an elastomeric material.

5. Sealing flange according to claim 4, wherein the sensor holder is essentially made of a thermosetting plastic.

6. Sealing flange according to claim 5, wherein the flange body is essentially made of steel sheet.

7. Sealing flange according to claim 1, wherein the sealing elements and the sensor holder are formed integrally on the flange body during manufacture in the same production tool.

8. Sealing flange according to claim 1, wherein the sealing element consists of a PTFE sealing disc which is bonded to the flange body by an elastomeric intermediate layer.

9. Sealing flange according to claim 1, wherein the flange body has at least one connecting element completely surrounded by the sensor holder.

10. Sealing flange according to claim 1, wherein the flange body has at least one positioning means for form-fit cooperation with the sensor holder.

11. Sealing flange according to claim 1, wherein the sensor element is releasably connected to the sensor hold.

12. Sealing flange according to claim 6, wherein the sealing elements and the sensor holder are formed integrally on the flange body during manufacture in the same production tool.

13. Sealing flange according to claim 2, wherein the sealing element consists of a PTFE sealing disc which is bonded to the flange body by an elastomeric intermediate layer.

14. Sealing flange according to claim 6, wherein the flange body has at least one connecting element completely surrounded by the sensor holder.

15. Sealing flange according to claim 14, wherein the flange body has at last one positioning means for form-fit cooperation with the sensor holder.

16. Sealing flange according to claim 10, wherein the sensor element is releasably connected to the sensor holder.
